(19) United States
(12) Patent Application Publication
(10) Pub. No.: US 2022/0363007 A1
(43) Pub. Date: Nov. 17, 2022

(54) PLASTICIZING DEVICE, THREE-DIMENSIONAL MODELING DEVICE, AND INJECTION MOLDING DEVICE

(71) Applicant: SEIKO EPSON CORPORATION, Tokyo (JP)

(72) Inventor: Junhua ZHANG, Shiojiri-shi (JP)

(21) Appl. No.: 17/663,497

(22) Filed: May 16, 2022

(30) Foreign Application Priority Data
May 17, 2021 (JP) 2021-083189

(51) Int. Cl. B29C 64/393; B29C 64/227; B29C 64/295; B29C 64/106; B33Y 30/00; B33Y 50/02; B29C 45/47; B29C 45/74; B29C 45/78

(52) U.S. Cl. CPC B29C 64/393; B29C 64/227; B29C 64/295; B29C 64/106; B33Y 30/00; B33Y 50/02; B29C 45/47; B29C 45/74; B29C 45/78; B29C 2945/76531; B29C 2945/76668

(57) ABSTRACT

A plasticizing device includes a drive motor, a flat screw, a barrel, a heater, a cooler, and a controller, wherein the controller executes a plasticizing step of controlling the drive motor, the heater, and the cooler to plasticize a material fed between the flat screw and the barrel to make the material plasticized outflow from a communication hole, a stopping step of stopping at least the drive motor and the heater after executing the plasticizing step to stop the plasticizing step, and a start-up step of starting up the heater and controlling at least one of the heater and the cooler so that the outer circumference of the flat screw becomes at a temperature no higher than in the plasticizing step when resuming the plasticizing step after a predetermined time elapses from the stopping step.

The present application is based on, and claims priority from JP Application Serial Number 2021-083189, filed May 17, 2021, the disclosure of which is hereby incorporated by reference herein in its entirety.

### BACKGROUND

### 1. Technical Field

The present disclosure relates to a plasticizing device, a three-dimensional modeling device, and an injection molding device.

### 2. Related Art

There has been known a three-dimensional modeling device which ejects a material plasticized by a plasticizing device to stack the material, and then cures the material to thereby shape a three-dimensional shaped article.

In, for example, JP-A-2010-241016 (Document 1), there is described a plasticizing delivery device provided with a barrel, a rotor, and a spiral groove, wherein a material inflow path opens on one end surface of the barrel, the rotor has an end surface having sliding contact with one end surface of the barrel, and the spiral groove is formed on one end surface of the rotor. The spiral groove is supplied with the material from an outer end portion in a radial direction, and at the same time, an inner end portion in the radial direction is communicated with an opening end of the material inflow path of the barrel.

In such a plasticizing delivery device as in Document 1, it is ideal for the material to gradually be plasticized from an outer circumference toward the center of the rotor. It has been found out that when the material has been plasticized in the outer circumferential portion of the rotor, the outer end portion in the radial direction of the spiral groove clogs to fail to supply a fresh material, or lose the power for conveying the material to fail to achieve sufficient plasticization, and thus, there occurs a bridge phenomenon in which the plasticization fails.

When starting up such a plasticizing delivery device as described above once again a little while later after stopping the plasticizing delivery device, the material which has been used last time remains in a solid state in the plasticizing delivery device. Therefore, the start-up of the plasticizing delivery device begins from heating the residual material with a heater, but the bridge phenomenon occurs on that occasion to fail to smoothly perform the start-up in some cases.

### SUMMARY

A plasticizing device according to an aspect of the present disclosure includes a drive motor, a flat screw which has a groove forming surface provided with a groove, and rotates with the drive motor, a barrel which has an opposed surface opposed to the groove forming surface, and is provided with a communication hole, a heater configured to heat a material fed between the flat screw and the barrel, a cooler configured to cool an outer circumference of the flat screw, and a controller configured to control the drive motor, the heater, and the cooler, wherein the controller executes a plasticizing step of controlling the drive motor, the heater, and the cooler to plasticize the material fed between the flat screw and the barrel to make the material plasticized outflow from the communication hole, a stopping step of stopping at least the drive motor and the heater after executing the plasticizing step to stop the plasticizing step, and a start-up step of starting up the heater and controlling at least one of the heater and the cooler so that the outer circumference of the flat screw becomes at a temperature no higher than in the plasticizing step when resuming the plasticizing step after a predetermined time elapses from the stopping step.

A three-dimensional modeling device according to an aspect of the present disclosure includes a plasticizing device configured to plasticize a material to obtain a plasticized material, and a nozzle configured to eject the plasticized material fed from the plasticizing device toward a stage, wherein the plasticizing device includes a drive motor, a flat screw which has a groove forming surface provided with a groove, and rotates with the drive motor, a barrel which has an opposed surface opposed to the groove forming surface, and is provided with a communication hole, a heater configured to heat a material fed between the flat screw and the barrel, a cooler configured to cool an outer circumference of the flat screw, and a controller configured to control the drive motor, the heater, and the cooler, and the controller executes a plasticizing step of controlling the drive motor, the heater, and the cooler to plasticize the material fed between the flat screw and the barrel to make the material plasticized outflow from the communication hole, a stopping step of stopping at least the drive motor and the heater after executing the plasticizing step to stop the plasticizing step, and a start-up step of starting up the heater and controlling at least one of the heater and the cooler so that the outer circumference of the flat screw becomes at a temperature no higher than in the plasticizing step when resuming the plasticizing step after a predetermined time elapses from the stopping step.

An injection molding device according to an aspect of the present disclosure includes a plasticizing device configured to plasticize a material to obtain a plasticized material, and a nozzle configured to inject the plasticized material fed from the plasticizing device into a molding die, wherein the plasticizing device includes a drive motor, a flat screw which has a groove forming surface provided with a groove, and rotates with the drive motor, a barrel which has an opposed surface opposed to the groove forming surface, and is provided with a communication hole, a heater configured to heat a material fed between the flat screw and the barrel, a cooler configured to cool an outer circumference of the flat screw, and a controller configured to control the drive motor, the heater, and the cooler, and the controller executes a plasticizing step of controlling the drive motor, the heater, and the cooler to plasticize the material fed between the flat screw and the barrel to make the material plasticized outflow from the communication hole, a stopping step of stopping at least the drive motor and the heater after executing the plasticizing step to stop the plasticizing step, and a start-up step of starting up the heater and controlling at least one of the heater and the cooler so that the outer circumference of the flat screw becomes at a temperature no higher than in the plasticizing step when resuming the plasticizing step after a predetermined time elapses from the stopping step.

### BRIEF DESCRIPTION OF THE DRAWINGS

FIG. 1 is a cross-sectional view schematically showing a three-dimensional modeling device according to an embodiment.

FIG. 2 is a perspective view schematically showing a flat screw of the three-dimensional modeling device according to the present embodiment.

FIG. 3 is a plan view schematically showing a barrel of the three-dimensional modeling device according to the present embodiment.

FIG. 4 is a flowchart for explaining processing of a controller of the three-dimensional modeling device according to the present embodiment.

FIG. 5 is a cross-sectional view for explaining plasticizing step of the controller of the three-dimensional modeling device according to the present embodiment.

FIG. 6 is a cross-sectional view schematically showing an injection molding device according to the present embodiment.

### DESCRIPTION OF AN EXEMPLARY EMBODIMENT

A preferred embodiment of the present disclosure will hereinafter be described in detail using the drawings. It should be noted that the embodiment described hereinafter does not unreasonably limit the contents of the present disclosure as set forth in the appended claims. Further, all of the constituents described hereinafter are not necessarily essential elements of the present disclosure.

### 1. Three-Dimensional Modeling Device

### 1.1. Overall Configuration

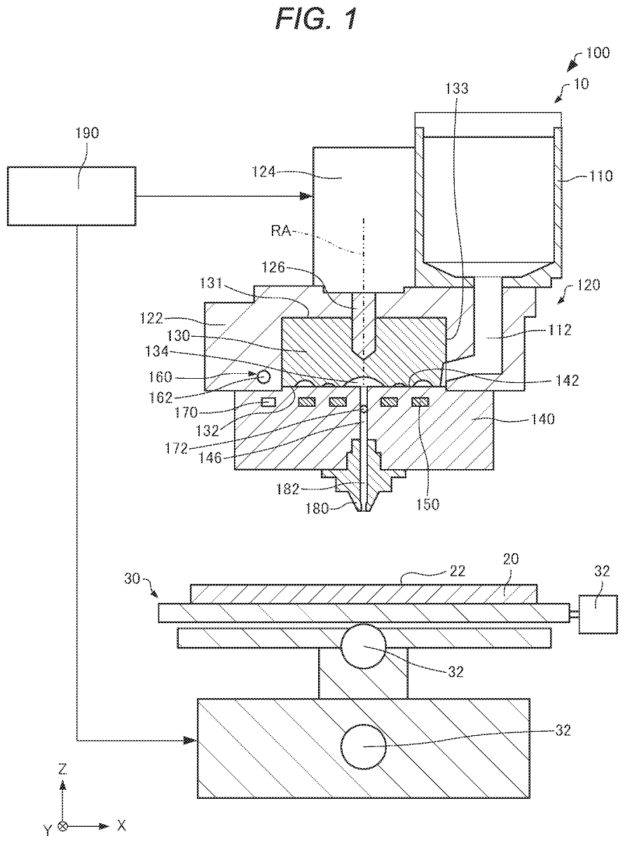

First, a three-dimensional modeling device according to the present embodiment will be described with reference to the drawings. FIG. 1 is a cross-sectional view schematically showing the three-dimensional modeling device 100 according to the present embodiment. It should be noted that in FIG. 1, an X axis, a Y axis, and a Z axis are shown as three axes perpendicular to each other. An X-axis direction and a Y-axis direction are each, for example, a horizontal direction. A Z-axis direction is, for example, a vertical direction.

As shown in FIG. 1, the three-dimensional modeling device 100 includes a modeling unit 10, a stage 20, and a moving mechanism 30.

The three-dimensional modeling device 100 drives the moving mechanism 30 to change a relative position between a nozzle 180 and the stage 20 while ejecting the plasticized material plasticized to the stage 20 from the nozzle 180 of the modeling unit 10. Thus, the three-dimensional modeling device 100 shapes a three-dimensional shaped article having a desired shape on the stage 20. The detailed configuration of the modeling unit 10 will be described later.

The stage 20 is transferred by the moving mechanism 30. On a depositional surface 22 of the stage 20, the plasticized material ejected from the nozzle 180 is deposited, and the three-dimensional shaped article is formed. The plasticized material can directly be deposited on the depositional surface 22 of the stage 20, or can also be deposited on the depositional surface 22 via a sample plate disposed on the stage 20.

The moving mechanism 30 changes a relative position between the modeling unit 10 and the stage 20. In the illustrated example, the moving mechanism 30 moves the stage 20 relatively to the modeling unit 10. The moving mechanism 30 is formed of, for example, a triaxial positioner for moving the stage 20 in the X-axis direction, the Y-axis direction, and the Z-axis direction with driving forces of three motors 32. The motors 32 are controlled by a controller 190.

It should be noted that the moving mechanism 30 can have a configuration of moving the modeling unit 10 without moving the stage 20. Alternatively, the moving mechanism 30 can have a configuration of moving both of the modeling unit 10 and the stage 20.

### 1.2. Modeling Unit

As shown in FIG. 1, the modeling unit 10 includes, for example, a material feeder 110, a plasticizing device 120, and the nozzle 180.

In the material feeder 110, there is put the material in the form of a pellet or a powder. The material feeder 110 feeds the material to be a raw material to the plasticizing device 120. The material feeder 110 is formed of, for example, a hopper. The material feeder 110 and the plasticizing device 120 are coupled to each other with a feed path 112 disposed below the material feeder 110. The material put in the material feeder 110 is fed to the plasticizing device 120 via the feed path 112. A type of the material to be fed by the material feeder 110 will be described later.

The plasticizing device 120 has, for example, a screw case 122, a drive motor 124, a flat screw 130, a barrel 140, a heater 150, a cooler 160, a temperature sensor 170, a pressure sensor 172, and the controller 190. The plasticizing device 120 plasticizes the material in the solid state fed from the material feeder 110 to generate the plasticized material in the paste form having fluidity, and then feeds the plasticized material to the nozzle 180.

It should be noted that plasticization is a concept including melting, and means to change a solid substance to a state having fluidity. Specifically, in the case of the material in which glass transition occurs, the plasticization means that the temperature of the material is made equal to or higher than the glass-transition point. In the case of the material in which the glass transition does not occur, the plasticization means that the temperature of the material is made equal to or higher than a melting point.

The screw case 122 is a chassis for housing the flat screw 130. On a lower surface of the screw case 122, there is disposed the barrel 140. In a space surrounded by the screw case 122 and the barrel 140, there is housed the flat screw 130.

The drive motor 124 is disposed on an upper surface of the screw case 122. The drive motor 124 is, for example, a servomotor. A shaft 126 of the drive motor 124 is coupled to an upper surface 131 of the flat screw 130. The drive motor 124 is controlled by the controller 190. It should be noted that although not shown in the drawings, it is possible for the shaft 126 of the drive motor 124 and the upper surface 131 of the flat screw 130 to be coupled to each other via a reduction gear.

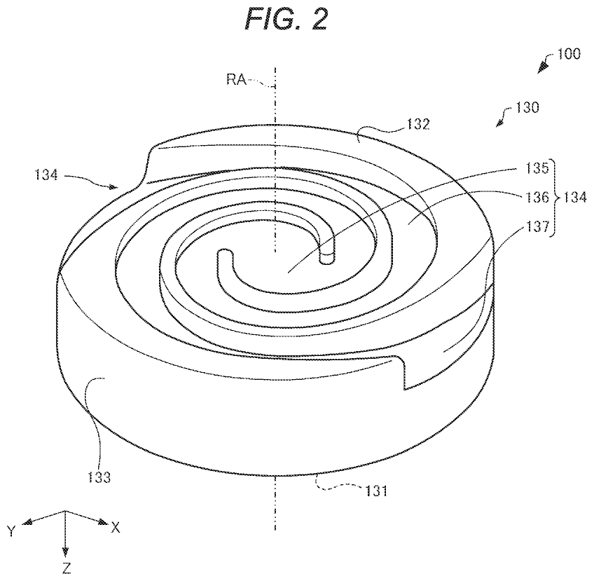

The flat screw 130 has a substantially columnar shape larger in size in a rotational axis RA direction than in a direction perpendicular to the rotational axis RA direction. In the illustrated example, the rotational axis RA is parallel to the Z direction. Due to the torque generated by the drive motor 124, the flat screw 130 rotates around the rotational axis RA. The flat screw 130 has the upper surface 131, a groove forming surface 132 at an opposite side to the upper surface 131, and a side surface 133 connecting the upper surface 131 and the groove forming surface 132 to each other. On the groove forming surface 132, there are formed first grooves 134. The side surface 133 is perpendicular to, for example, the groove forming surface 132. Here, FIG. 2 is a perspective view schematically showing the flat screw 130. It should be noted that FIG. 2 shows a state in which a vertical positional relationship is reversed from the state shown in FIG. 1 for the sake of convenience. Further, in FIG. 1, the flat screw 130 is illustrated in a simplified manner.

As shown in FIG. 2, on the groove forming surface 132 of the flat screw 130, there are formed the first grooves 134. The first grooves 134 each have, for example, a central portion 135, a connection portion 136, and a material introduction portion 137. The central portion 135 is opposed to a communication hole 146 provided to the barrel 140. The central portion 135 is communicated with the communication hole 146. The connection portion 136 connects the central portion 135 and the material introduction portion 137 to each other. In the illustrated example, the connection portion 136 is disposed from the central portion 135 toward an outer circumference of the groove forming surface 132 so as to form a spiral shape. The material introduction portion 137 is disposed on the outer circumference of the groove forming surface 132. In other words, the material introduction portion 137 is disposed on the side surface 133 of the flat screw 130. The material fed from the material feeder 110 is introduced into the first grooves 134 from the material introduction portions 137, and is conveyed to the communication hole 146 provided to the barrel 140 through the connection portions 136 and the central portions 135. In the illustrated example, the number of the first grooves 134 disposed is two.

It should be noted that the number of the first grooves 134 is not particularly limited. Although not shown in the drawings, it is possible to dispose three or more first grooves 134, or it is also possible to dispose just one first groove 134.

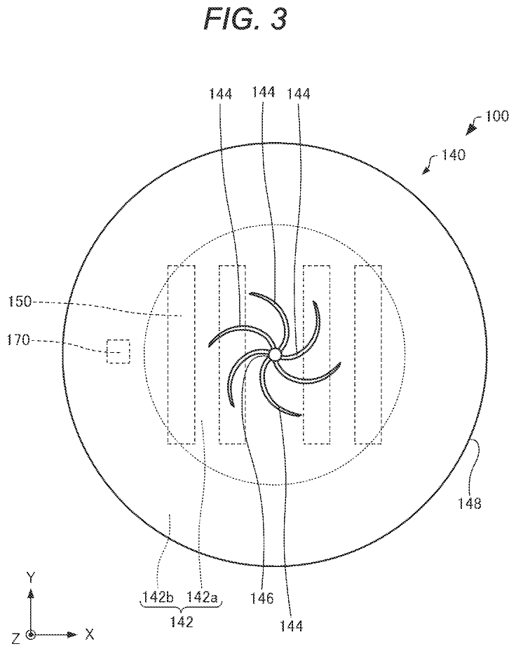

As shown in FIG. 1, the barrel 140 is disposed below the flat screw 130. The barrel 140 has an opposed surface 142 opposed to the groove forming surface 132 of the flat screw 130. At the center of the opposed surface 142, there is formed the communication hole 146 communicated with the first grooves 134. Here, FIG. 3 is a plan view schematically showing the barrel 140. It should be noted that in FIG. 1, the barrel 140 is illustrated in a simplified manner for the sake of convenience.

As shown in FIG. 3, on the opposed surface 142 of the barrel 140, there are formed second grooves 144 and the communication hole 146. There is formed a plurality of the second grooves 144. Although there are formed the six second grooves 144 in the illustrated example, the number thereof is not particularly limited. The plurality of second grooves 144 is formed on the periphery of the communication hole 146 when viewed from the Z-axis direction. The second grooves 144 are each coupled to the communication hole 146 at one end thereof, and each extend from the communication hole 146 toward outer circumference 148 of the barrel 140 so as to form a spiral shape. The second grooves 144 each have a function of guiding the plasticized material to the communication hole 146.

It should be noted that the shape of the second groove 144 is not particularly limited, and can also be, for example, a linear shape. Further, the second grooves 144 are each not required to be coupled to the communication hole 146 at one end. Further, the second grooves 144 are each not required to be formed on the opposed surface 142. It should be noted that it is preferable for the second grooves 144 to be formed on the opposed surface 142 taking the fact that the plasticized material is efficiently guided to the communication hole 146 into consideration.

The opposed surface 142 of the barrel 140 has a high-temperature region 142a and a low-temperature region 142b. The high-temperature region 142a is a region which is heated by the heater 150 to a temperature no lower than the plasticization temperature of the material when plasticizing the material. The low-temperature region 142b is a region which becomes at a temperature lower than the plasticization temperature of the material when plasticizing the material. In other words, the low-temperature region 142b is a region which fails to reach the plasticization temperature of the material when plasticizing the material. When plasticizing the material, the temperature of the low-temperature region 142b is lower than the temperature of the high-temperature region 142a. It should be noted that the “plasticization temperature” means the temperature at which the plasticization begins, means the glass-transition point in the case of the material in which the glass transition occurs, and means the melting point in the case of the material in which the glass transition does not occur. The low-temperature region 142b surrounds the high-temperature region 142a when viewed from the Z-axis direction. In the illustrated example, the shape of the low-temperature region 142b is a ring-like shape, and the shape of the high-temperature region 142a is a circular shape. The communication hole 146 is located at, for example, the center of the high-temperature region 142a.

The heater 150 is provided to the barrel 140. In the illustrated example, the heater 150 is constituted by four rod heaters provided to the barrel 140. The heater 150 heats the material fed between the flat screw 130 and the barrel 140. The output of the heater 150 is controlled by the controller 190. The plasticizing device 120 heats the material while conveying the material toward the communication hole 146 with the flat screw 130, the barrel 140, and the heater 150 to thereby generate the plasticized material, and then makes the plasticized material thus generated outflow from the communication hole 146.

The cooler 160 cools the outer circumference of the flat screw 130. “The outer circumference of the flat screw 130” means the side surface 133 of the flat screw 130.

As shown in FIG. 1, the cooler 160 has a cooling flow channel 162 through which a refrigerant flows, and a circulation device not shown for circulating the refrigerant. In the illustrated example, the cooling flow channel 162 is provided to the screw case 122. The cooling flow channel 162 surrounds the flat screw 130 when viewed from, for example, the Z-axis direction. The cooling flow channel 162 surrounds the heater 150 when viewed from, for example, the Z-axis direction. When viewed from the Z-axis direction, the distance between the cooler 160 and the side surface 133 is shorter than the distance between the heater 150 and the side surface 133. The refrigerant flowing through the cooling flow channel 162 is not particularly limited, but there can be cited, for example, water. Due to the heater 150 and the cooler 160, there is formed a temperature gradient in which the temperature gradually rises from the outer circumference 148 of the barrel 140 toward the communication hole 146.

The temperature sensor 170 is provided to the barrel 140. The temperature sensor 170 detects the temperature of the opposed surface 142 of the barrel 140. The temperature sensor 170 is, for example, a thermocouple, a thermistor, or an infrared sensor. It should be noted that although not shown in the drawings, it is possible for the temperature sensor 170 to be provided to the flat screw 130. In this case, the temperature sensor 170 detects the temperature of the groove forming surface 132.

The pressure sensor 172 is provided to the communication hole 146. The pressure sensor 172 detects the pressure in the communication hole 146.

The nozzle 180 is disposed below the barrel 140. The nozzle 180 ejects the plasticized material fed from the plasticization device 120 toward the stage 20. The nozzle 180 is provided with a nozzle flow channel 182. The nozzle flow channel 182 is communicated with the communication hole 146. The plasticized material fed from the communication hole 146 is ejected from the nozzle 180 through the nozzle flow channel 182.

The controller 190 is formed of a computer provided with, for example, a processor, a main storage device, and an input/output interface for performing input/output of signals with the outside. The controller 190 exerts a variety of functions due to, for example, the processor executing a program retrieved in the main storage device. Specifically, the controller 190 controls the drive motor 124, the heater 150, the cooler 160, and the motor 32 of the moving mechanism 30. It should be noted that it is also possible for the controller 190 to be formed by a combination of a plurality of circuits instead of the computer. Hereinafter, the processing of the controller 190 will be described.

### 1.3. Processing of Controller

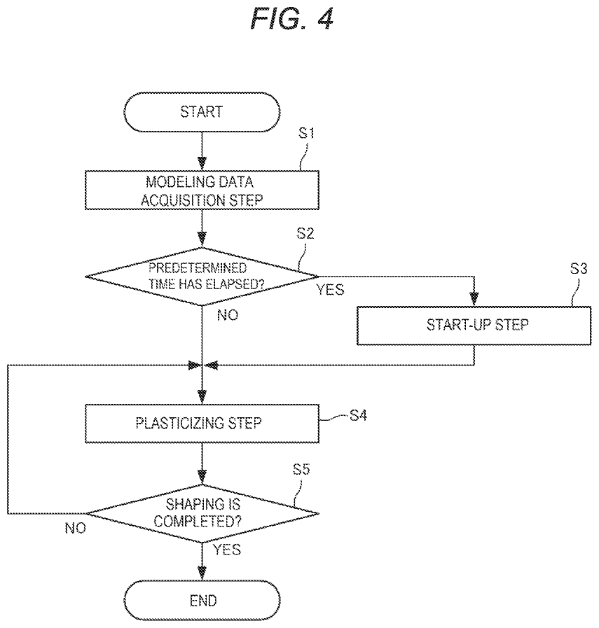

FIG. 4 is a flowchart for explaining the processing of the controller 190.

The user operates, for example, an operation section not shown to output a processing start signal for starting the processing to the controller 190. The operation section is realized by, for example, a mouse, a keyboard, or a touch panel. The controller 190 starts the processing when receiving the processing start signal. Each of steps of the processing will hereinafter be described.

### 1.3.1. Modeling Data Acquisition Step

First, as shown in FIG. 4, the controller 190 executes a modeling data acquisition step of obtaining modeling data for shaping the three-dimensional shaped article as the step 1. The modeling data includes information related to a moving path of the nozzle 180 with respect to the stage 20, an amount of the plasticized material to be ejected from the nozzle 180, and so on. The modeling data is formed by making, for example, slicer software installed in a computer coupled to the three-dimensional modeling device 100 retrieve shape data. The shape data is data representing a target shape of the three-dimensional shaped article formed using three-dimensional CAD (Computer Aided Design) software, three-dimensional CG (Computer Graphics) software, or the like. As the shape data, there is used data in, for example, an STL (Standard Triangulated Language) format or an AMF (Additive Manufacturing File Format). The slicer software divides the target shape of the three-dimensional shaped article into layers of a predetermined thickness, and generates the modeling data for each of the layers. The modeling data is represented by a G code, an M code, or the like. The controller 190 obtains the modeling data from a computer coupled to the three-dimensional modeling device 100 or a recording medium such as a USB (Universal Serial Bus) memory.

It should be noted that the modeling data acquisition step can be performed after a determination step of determining whether or not a predetermined time has elapsed, and before a plasticizing step.

### 1.3.2. Determination Step on Whether or Not Predetermined Time Has Elapsed

Then, as the step S2, the controller 190 executes the determination step of determining whether or not a predetermined time has elapsed after a stopping step has been executed after executing the previous plasticizing step. The predetermined time is not particularly limited, but is, for example, one hour. The plasticizing step is a step of controlling the drive motor 124, the heater 150, and the cooler 160 to thereby plasticize the material fed between the flat screw 130 and the barrel 140 to make the material outflow from the communication hole 146. The stopping step is a step of stopping at least the drive motor 124 and the heater 150 to stop the plasticizing step after executing the plasticizing step.

### 1.3.3. Start-Up Step

When it is determined in the step S2 that the predetermined time has elapsed (in the case of “YES” in the step S2), the controller 190 executes a start-up step as the step S3 before resuming the plasticizing step.

It should be noted that in the example described above, the start-up step is executed when it has been determined in the step S2 that the predetermined time has elapsed, but it is possible for the controller 190 to execute the start-up step as the step S3 instead of the step S2 before resuming the plasticizing step when it is determined that a detection value of the temperature sensor 170 is lower than a predetermined value.

In the start-up step, a fresh material is not fed from the material feeder 110 to the material introduction portions 137 of the first grooves 134. The start-up step is started in a state in which the material having been used in the previous plasticizing step remains in the first grooves 134. The material remaining in the first grooves 134 is in the solid state.

In the start-up step, the controller 190 starts up the heater 150 and the cooler 160, and controls the cooler 160 so that the outer circumference of the flat screw 130 becomes at a temperature no higher than in the plasticizing step. It is possible for the controller 190 to control the cooler 160 to thereby make the temperature at the outer circumference of the flat screw 130 in the start-up step equal to the temperature at the outer circumference of the flat screw 130 in the plasticizing step, or lower than the temperature at the outer circumference of the flat screw in the plasticizing step.

In the start-up step, a period from when starting up the heater 150 and the cooler 160 to rotate the flat screw 130 to when the outer circumference of the flat screw 130 becomes at a temperature no higher than in the plasticizing step is no shorter than 3 seconds. That period is not particularly limited providing the period is no shorter than 3 seconds, and can be, for example, 5 minutes, or can also be 10 minutes.

The controller 190 further controls the cooler 160 so that the area of the high-temperature region 142a of the opposed surface 142 in the start-up step becomes no larger than the area of the high-temperature region 142a in the plasticizing step.

Specifically, the controller 190 controls the cooler 160 so that the temperature of the refrigerant flowing through the cooler 160 in the start-up step becomes lower than the temperature of the refrigerant flowing through the cooler 160 in the plasticizing step. Thus, it is possible to make the temperature at the outer circumference of the flat screw 130 in the start-up step no higher than the temperature at the outer circumference of the flat screw 130 in the plasticizing step. Further, it is possible to make the area of the high-temperature region 142a in the start-up step no larger than the high-temperature region 142a in the plasticizing step. It is possible for the controller 190 to change the temperature of the refrigerant by controlling, for example, the output of the circulation device for circulating the refrigerant. A difference between the temperature of the refrigerant in the start-up step and the temperature of the refrigerant in the plasticizing step is, for example, no lower than 10° C. and no higher than 50° C., preferably no lower than 20° C. and no higher than 40° C., and more preferably 30° C.

The controller 190 controls the cooler 160 based on, for example, the detection value of the temperature sensor 170 in the start-up step. In other words, the controller 190 controls the cooler 160 so that the detection value of the temperature sensor 170 becomes a predetermined value.

The controller 190 controls the cooler 160 based on, for example, a detection value of the pressure sensor 172 in the start-up step. In other words, the controller 190 controls the cooler 160 so that the detection value of the pressure sensor 172 becomes a predetermined value.

The controller 190 rotates the flat screw 130 after a predetermined time elapses from when starting up the heater 150 in the start-up step. The predetermined time is not particularly limited, but is, for example, no less than 1 minute and no more than 30 minutes. The controller 190 controls the drive motor 124 to thereby rotate the flat screw 130.

The controller 190 rotates the flat screw 130 at a lower rotational speed than in the plasticizing step in, for example, the start-up step. Specifically, the controller 190 controls the drive motor 124 so that the rotational speed of the flat screw 130 in the start-up step becomes lower than the rotational speed of the flat screw 130 in the plasticizing step. The rotational speed of the flat screw 130 in the start-up step is, for example, no higher than one third of the rotational speed of the flat screw 130 in the plasticizing step.

The controller 190 controls the drive motor 124 based on, for example, the detection value of the temperature sensor 170 in the start-up step. Specifically, when the detection value of the temperature sensor 170 has become a predetermined value, the controller 190 drives the drive motor 124 to rotate the flat screw 130.

The controller 190 controls the moving mechanism 30 based on, for example, the modeling data thus obtained while rotating the flat screw 130 in the start-up step. Thus, it is possible to form a shaped layer constituting the three-dimensional shaped article on the stage 20.

The controller 190 terminates the start-up step, for example, after a predetermined time elapses from when driving the drive motor 124. The information related to the predetermined time is included in, for example, the modeling data.

It should be noted that in the example described above, the controller 190 performs the step of controlling the cooler 160 in the start-up step so that the outer circumference of the flat screw 130 becomes at the temperature no higher than in the plasticizing step.

In contrast, it is possible for the controller 190 to control the heater 150 instead of the cooler 160 in the start-up step to make the temperature at the outer circumference of the flat screw 130 no higher than the temperature in the plasticizing step. It is possible for the controller 190 to control the heater 150 in the start-up step so that the temperature of the material becomes a temperature no lower than the plasticization temperature of the material and no higher than the temperature in the plasticizing step. For example, it is possible for the controller 190 to make the temperature of the heater 150 in the start-up step lower than the temperature in the plasticizing step to thereby make the temperature at the outer circumference of the flat screw 130 no higher than the temperature in the plasticizing step.

Alternatively, it is possible for the controller 190 to control both of the heater 150 and the cooler 160 in the start-up step to make the temperature at the outer circumference of the flat screw 130 no higher than the temperature in the plasticizing step.

Further, in the above description, there is described the example in which the drive motor 124 is driven to rotate the flat screw 130 when the detection value of the temperature sensor 170 becomes a predetermined value, but it is possible for the controller 190 to drive the drive motor 124 to rotate the flat screw 130 when the detection value of the pressure sensor 172 becomes a predetermined value. In other words, in the start-up step, the controller 190 controls the drive motor 124 based on the detection value of the pressure sensor 172.

Alternatively, it is possible for the controller 190 to drive the drive motor 124 to rotate the flat screw 130 when both of the detection value of the temperature sensor 170 and the detection value of the pressure sensor 172 become no lower than the predetermined values in the start-up step.

### 1.3.4. Plasticizing Step

After the start-up step is terminated, the controller 190 executes the plasticizing step as the step S4. Alternatively, when it is determined in the step S2 that the predetermined time has not elapsed (in the case of “NO” in the step S2), the controller 190 executes the plasticizing step as the step S4. When the predetermined time has not elapsed, since the temperature of the flat screw 130 and the barrel 140 is still high, and therefore, the material remaining in the central portion 135 of each of the grooves 134 is in the plasticized state. Therefore, it is possible to stably perform the plasticization of the material in the plasticizing step without performing the start-up step.

It should be noted that in the example described above, the plasticizing step is executed when it has been determined in the step S2 that the predetermined time has not elapsed, but it is possible for the controller 190 to execute the plasticizing step as the step S4 instead of the step S2 when it is determined that the detection value of the temperature sensor 170 is no lower than the predetermined value.

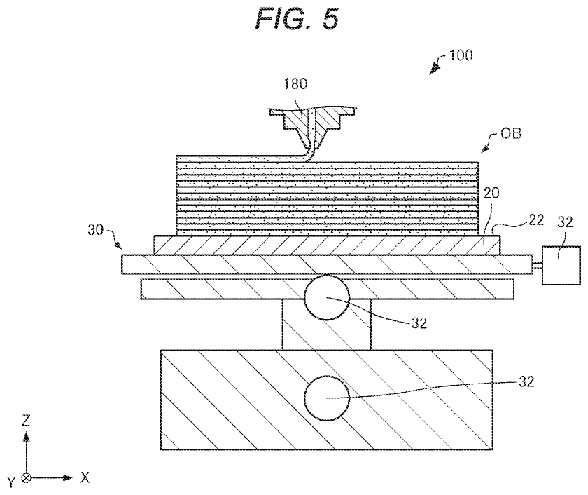

In the plasticizing step, the fresh material is fed from the material feeder 110 to the material introduction portions 137 of the flat screw 130. The feeding of the material is performed until the plasticizing step is terminated. In the plasticizing step, the controller 190 plasticizes the material fed between the flat screw 130 and the barrel 140 to generate the plasticized material, and then makes the plasticized material outflow from the communication hole 146. The controller 190 continues to generate the plasticized material until the plasticizing step is terminated. Here, FIG. 5 is a cross-sectional view for explaining the plasticizing step.

In the plasticizing step, as shown in FIG. 5, the controller 190 controls the moving mechanism 30 based on the modeling data obtained to execute the step of ejecting the plasticized material from the nozzle 180 toward the depositional surface 22 while controlling the moving mechanism 30 to change the relative position between the nozzle 180 and the depositional surface 22. Thus, for example, there is formed a first layer out of the plurality of shaped layers constituting the three-dimensional shaped article OB.

It should be noted that when the shaped layers have already been formed in the start-up step, the controller 190 performs the formation of the shaped layer from the rest of the shaped layers formed in the start-up step based on the modeling data thus obtained. For example, when the first layer has been formed in the start-up step, the controller 190 forms a second layer of the shaped layers in the plasticizing step. Alternatively, when the formation progresses to a middle of the first layer in the start-up step, the controller 190 forms the shaped layers from the middle of the first layer in the plasticizing step.

In the plasticizing step, the controller 190 makes the temperature of, for example, the refrigerant of the cooler 160 higher than in the start-up step. It is possible for the controller 190 to control the cooler 160 based on the detection value of the temperature sensor 170, or control the cooler 160 based on the detection value of the pressure sensor 172.

In the plasticizing step, the controller 190 makes the temperature of, for example, the heater 150 higher than in the start-up step. It is possible for the controller 190 to control the heater 150 based on the detection value of the temperature sensor 170, or control the heater 150 based on the detection value of the pressure sensor 172.

In the plasticizing step, the controller 190 makes the rotational speed of the flat screw 130 higher than in the start-up step. It is possible for the controller 190 to control the drive motor 124 based on the detection value of the temperature sensor 170, or control the drive motor 124 based on the detection value of the pressure sensor 172.

The controller 190 changes the temperature at the outer circumference of the flat screw 130 in accordance with the type of the material to be fed in the plasticizing step. Specifically, when the material to be fed is a crystalline material, the controller 190 makes the temperature at the outer circumference of the flat screw 130 higher compared to when the material to be fed is a non-crystalline material. For example, the controller 190 controls the cooler 160 so that the temperature at the outer circumference of the flat screw 130 becomes a first temperature when the material thus fed is the non-crystalline material, or controls the cooler 160 so that the temperature at the outer circumference of the flat screw 130 becomes a second temperature higher than the first temperature when the material to be fed is the crystalline material. The controller 190 obtains the information of the type of the material to be fed from, for example, the modeling data. As the crystalline material, there can be cited, for example, a PEEK (polyether ether ketone). As the non-crystalline material, there can be cited, for example, ABS (acrylonitrile-butadiene-styrene) resin.

It should be noted that it is possible for the controller 190 to change the temperature at the outer circumference of the flat screw 130 in accordance with the type of the material to be fed in the start-up step. Specifically, when the material to be fed is the crystalline material, it is possible for the controller 190 to make the temperature at the outer circumference of the flat screw 130 higher compared to when the material to be fed is the non-crystalline material.

### 1.3.5. Determination Step on whether or Not Formation of All Shaped Layers is Completed

Then, as shown in FIG. 4, the controller 190 executes the step of determining whether or not the formation of all of the shaped layers of the three-dimensional shaped article OB as the step S5 based on the modeling data thus obtained has been completed. When there has not been determined that the formation of all of the shaped layers of the three-dimensional shaped article OB has been completed (“NO” in the step S5), the controller 190 returns to the plasticizing step to form, for example, the remaining shaped layers of the three-dimensional shaped article OB. In contrast, when it has been determined that the formation of all of the shaped layers of the three-dimensional shaped article OB has been completed (“YES” in the step S5), the controller 190 terminates the step. The controller 190 repeatedly performs the processing in the step S4 and the step S5 until it is determined that the formation of all of the shaped layers of the three-dimensional shaped article OB has been completed in the step S5, to thereby shape the three-dimensional shaped article OB.

### 1.4. Functions and Advantages

In the plasticizing device 120, the controller 190 executes the plasticizing step in which the material fed between the flat screw 130 and the barrel 140 is plasticized and is then made to outflow from the communication hole 146 by controlling the drive motor 124, the heater 150, and the cooler 160, executes the stopping step in which at least the drive motor 124 and the heater 150 are stopped after the execution of the plasticizing step to stop the plasticizing step, and executes the start-up step in which the heater 150 is started up and then at least one of the heater 150 and the cooler 160 is controlled so that the outer circumference of the flat screw 130 becomes at the temperature no higher than in the plasticizing step when resuming the plasticizing step after a predetermined time elapses from the stopping step. Therefore, in the plasticizing device 120, it is possible to prevent the bridge phenomenon from occurring, and thus, it is possible to smoothly start up the device. The reason therefor will hereinafter be described.

In the plasticizing step, the flat screw is rotating, and the fresh material is fed from the material introduction portions of the first grooves provided to the flat screw. Therefore, the outer circumference of the flat screw is also cooled by the material newly fed in addition to the cooling by the cooler. In contrast, when starting up the device, since the material which has been used last time remains in the first grooves, the step starts from heating the material with the heater before rotating the flat screw. On that occasion, when cooling the outer circumference of the flat screw in substantially the same condition as in the plasticizing step, since the fresh material is not fed to the material introduction portions of the first grooves at the start-up, the temperature at the outer circumference of the flat screw becomes higher accordingly. When the temperature at the outer circumference of the flat screw becomes high and the material is plasticized in the outer circumferential portion, the material introduction portions of the first grooves clog to fail to feed the fresh material, or the power for conveying the material toward the central portions of the first grooves is lost to fail to achieve the sufficient plasticization, and thus, the possibility that the bridge phenomenon occurs increases.

As described above, in the plasticizing device 120, since at least one of the heater 150 and the cooler 160 is controlled in the start-up step so that the outer circumference of the flat screw 130 becomes lower in temperature than in the plasticizing step, it is possible to suppress the rise in temperature at the outer circumference of the flat screw 130 caused by the fact that the fresh material is not fed. Therefore, in the plasticizing device 120, it is possible to prevent the material from being plasticized at the outer circumference of the flat screw 130. Thus, it is possible to smoothly start up the device while preventing the bridge phenomenon from occurring. Therefore, it is possible for the three-dimensional modeling device 100 to shape the three-dimensional shaped article OB high in quality.

In the plasticizing device 120, the controller 190 rotates the flat screw 130 after the predetermined time elapses from when starting up the heater 150 in the start-up step. Therefore, in the plasticizing device 120, it is possible to reduce the load on the drive motor 124. For example, when rotating the flat screw before the predetermined time does not elapse from starting up the heater, the material which has been used last time is not sufficiently plasticized to make the load on the drive motor high in some cases.

In the plasticizing device 120, the controller 190 rotates the flat screw 130 in the start-up step at a lower rotational speed than in the plasticizing step. Therefore, in the plasticizing device 120, it is possible to reduce the load on the drive motor 124 even in the state in which the material which has been used last time is supposedly not sufficiently plasticized.

In the plasticizing device 120, the controller 190 controls the cooler 160 in the start-up step so that the temperature at the outer circumference of the flat screw 130 becomes the temperature no higher than in the plasticizing step. Therefore, in the plasticizing device 120, it is possible to prevent the material from being plasticized at the outer circumference of the flat screw 130.

In the plasticizing device 120, the controller 190 controls the heater 150 in the start-up step so that the temperature of the material becomes a temperature no lower than the plasticization temperature of the material and no higher than the temperature in the plasticizing step. Therefore, in the plasticizing device 120, it is possible to more surely prevent the material from being plasticized at the outer circumference of the flat screw 130.

In the plasticizing device 120, the opposed surface 142 has the high-temperature region 142a which is heated by the heater 150 to the temperature no lower than the plasticization temperature of the material, and the controller 190 controls at least one of the heater 150 and the cooler 160 so that the area of the high-temperature region 142a in the start-up step is no larger than the area of the high-temperature region 142a in the plasticizing step. Therefore, in the plasticizing device 120, it is possible to more surely prevent the material from being plasticized at the outer circumference of the flat screw 130.

In the plasticizing device 120, there is included the temperature sensor 170 for detecting the temperature of the groove forming surface 132 or the opposed surface 142, and the controller 190 controls at least one of the cooler 160, the heater 150, and the drive motor 124 based on the detection value of the temperature sensor 170 in the start-up step. Therefore, in the plasticizing device 120, it is possible to smoothly execute the start-up step based on the detection value of the temperature sensor 170.

In the plasticizing device 120, there is included the pressure sensor 172 for detecting the pressure in the communication hole 146, and the controller 190 controls at least one of the cooler 160, the heater 150, and the drive motor 124 based on the detection value of the pressure sensor 172 in the start-up step. Therefore, in the plasticizing device 120, it is possible to smoothly execute the start-up step based on the detection value of the pressure sensor 172.

In the plasticizing device 120, the controller 190 changes the temperature at the outer circumference of the flat screw 130 in accordance with the type of the material. Therefore, in the plasticizing device 120, it is possible to optimize a temperature distribution in the flat screw 130 and the barrel 140 in accordance with the type of the material.

In the plasticizing device 120, when the material is the crystalline material, the controller 190 makes the temperature at the outer circumference of the flat screw 130 higher compared to when the material is the non-crystalline material. Therefore, in the plasticizing device 120, even when the material is the crystalline material, it is possible to optimize the temperature distribution in the flat screw 130 and the barrel 140. When the material is crystalline, the plasticization is more difficult than when the material is non-crystalline.

### 1.5. Material to be Fed

As the material to be fed from the material feeder 110, there can be cited materials using a variety of materials such as a material having a thermoplastic property, a metal material, or a ceramic material as a chief material. Here, the “chief material” means a material playing a central role for forming the shape of the shaped article, and means a material having a content rate no lower than 50% by mass in the shaped article. The material described above includes those obtained by melting these chief materials alone, and those obtained by melting some of the components included therein together with the chief material in paste form.

As the material having the thermoplastic property, it is possible to use, for example, the thermoplastic resin. As the thermoplastic resin, there can be cited general-purpose engineering plastic such as ABS resin, polypropylene (PP), polyethylene (PE), polyacetal (POM), polyvinyl chloride (PVC), polyamide (PA), polylactic acid (PLA), polyphenylene sulfide (PPS), polycarbonate (PC), modified polyphenylene ether, polybutylene terephthalate, and polyethylene terephthalate, and engineering plastic such as polysulfone, polyether sulfone, polyphenylene sulfide, polyarylate, polyimide, polyamide-imide, polyetherimide, and PEEK.

In the material having the thermoplastic property, there can be mixed an additive agent such as wax, flame retardant, antioxidant, or thermal stabilizer, and so on in addition to pigment, metal, and ceramic. In the plasticizing device 120, the material having the thermoplastic property is plasticized by the rotation of the flat screw 130 and heating by the heater 150 to be transformed into the melted state. Further, the plasticized material generated in such a manner is ejected from the nozzle 180, and then cures due to drop in temperature. It is desirable for the material having the thermoplastic property to be heated at a temperature no lower than the glass-transition point and then ejected from the nozzles 180 in a completely melted state.

In the plasticizing device 120, a metal material, for example, can be used as the chief material instead of the material having the thermoplastic property described above. In this case, it is desirable that components to be melted when generating the plasticized material are mixed in a power material obtained by powdering the metal material, and then the mixture is loaded into the plasticizing device 120.

As the metal material, there can be cited, for example, magnesium (Mg), iron (Fe), cobalt (Co), chromium (Cr), aluminum (Al), titanium (Ti), copper (Cu), or nickel (Ni) as a single metal, or alloys including one or more of these metals, or maraging steel, stainless steel, cobalt-chromium-molybdenum, titanium alloy, nickel alloy, aluminum alloy, cobalt alloy, or cobalt-chrome alloy.

In the plasticizing device 120, it is possible to use a ceramic material as the chief material instead of the metal material described above. As the ceramic material, there can be cited, for example, oxide ceramic such as silicon dioxide, titanium dioxide, aluminum oxide, or zirconium oxide, and non-oxide ceramic such as aluminum nitride.

The powder material of the metal material or the ceramic material to be fed from the material feeder 110 can also be a mixed material obtained by mixing a plurality of types of single metal powder, alloy powder, or ceramic material powder. Further, the powder material of the metal material or the ceramic material can also be coated with, for example, the thermoplastic resin described above or other thermoplastic resin. In this case, it is also possible to assume that the thermoplastic resin is melted to develop the fluidity in the plasticizing device 120.

It is also possible to add, for example, a solvent to the powder material of the metal material or the ceramic material to be fed from the material feeder 110. As the solvent, there can be cited, for example, water; a (poly)alkylene glycol monoalkyl ether group such as ethylene glycol monomethyl ether, ethylene glycol monoethyl ether, propylene glycol monomethyl ether, or propylene glycol monoethyl ether; an ester acetate group such as ethyl acetate, n-propyl acetate, isopropyl acetate, n-butyl acetate, or isobutyl acetate; an aromatic hydrocarbon group such as benzene, toluene, or xylene; a ketone group such as methyl ethyl ketone, acetone, methyl isobutyl ketone, ethyl-n-butyl ketone, diisopropyl ketone, or acethylacetone; an alcohol group such as ethanol, propanol, or butanol; a tetraalkylammonium acetate group; a sulfoxide series solvent such as dimethyl sulfoxide, or diethyl sufoxide; a pyridine series solvent such as pyridine, γ-picoline, or 2,6-lutidine; tetraalkylammonium acetate (e.g., tetrabutylammonium acetate); and an ionic liquid such as butyl carbitol acetate.

Besides the above, it is also possible to add, for example, a binder to the powder material of the metal material or the ceramic material to be fed from the material feeder 110. As the binder, there can be cited, for example, acrylic resin, epoxy resin, silicone resin, cellulosic resin, or other synthetic resin, polylactic acid (PLA), polyamide (PA), polyphenylene sulfide (PPS), PEEK, or other thermoplastic resin.

### 2. Injection Molding Device

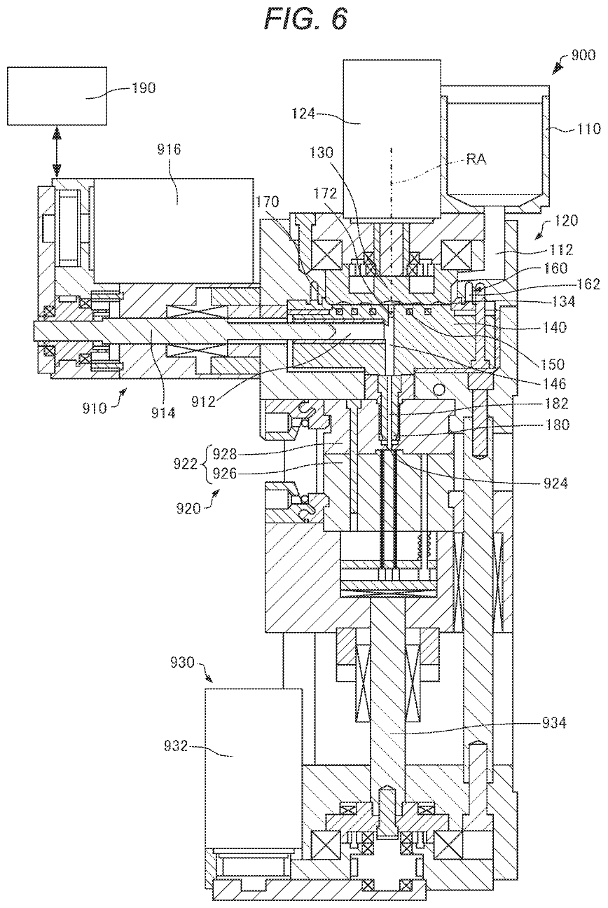

Then, an injection molding device according to the present embodiment will be described with reference to the drawings. FIG. 6 is a cross-sectional view schematically showing the injection molding device 900 according to the present embodiment.

As shown in FIG. 6, the injection molding device 900 includes, for example, the plasticizing device 120 described above. The injection molding device 900 further includes, for example, the material feeder 110, the nozzle 180, an injection mechanism 910, a mold section 920, and a mold clamper 930.

The plasticizing device 120 plasticizes the material fed to the first grooves 134 of the flat screw 130 to generate the plasticized material in the paste form having fluidity, and then guides the plasticized material from the communication hole 146 to the injection mechanism 910.

The injection mechanism 910 has, for example, a cylinder 912, a plunger 914, and a plunger driver 916. The cylinder 912 is a member which has a substantially cylindrical shape, and is coupled to the communication hole 146. The plunger 914 moves inside the cylinder 912. The plunger 914 is driven by the plunger driver 916 constituted by a motor, gears, and so on. The plunger driver 916 is controlled by the controller 190.

The injection mechanism 910 slides the plunger 914 inside the cylinder 912 to thereby execute a weighing operation and an injection operation. The weighing operation means an operation of moving the plunger 914 toward a direction of getting away from the communication hole 146 to thereby guide the plasticized material located in the communication hole 146 to the inside of the cylinder 912, and then measuring the weight of the plasticized material inside the cylinder 912. The injection operation means an operation of moving the plunger 914 toward a direction of coming closer to the communication hole 146 to thereby inject the plasticized material located inside the cylinder 912 into the mold section 920 via the nozzle 180.

The nozzle 180 injects the plasticized material fed from the plasticizing device 120 into a molding die 922 of the mold section 920. Specifically, by the weighing operation and the injection operation described above being executed, the plasticized material weighed inside the cylinder 912 is fed from the injection mechanism 910 to the nozzle 180 via the communication hole 146. Further, the plasticized material is injected from the nozzle 180 into the mold section 920.

The mold section 920 has the molding die 922. The molding die 922 is a metallic mold. The molding die 922 has a movable mold 926 and a stationary mold 928 opposed to each other, and has a cavity 924 between the movable mold 926 and the stationary mold 928. The plasticized material is injected from the nozzle 180 into the cavity 924 of the molding die 922. The cavity 924 is a space corresponding to a shape of a molded object. The plasticized material flowing into the cavity 924 is cooled to be solidified. Thus, the molded object is formed. The materials of the movable mold 926 and the stationary mold 928 are each metal. It should be noted that the materials of the movable mold 926 and the stationary mold 928 can each be ceramic or resin.

The mold clamper 930 has, for example, a mold driver 932 and a ball screw section 934. The mold driver 932 can be constituted by, for example, a motor and gears. The mold clamper 932 is coupled to the movable mold 926 via the ball screw section 934. The drive by the mold driver 932 is controlled by the controller 190. The ball screw section 934 transmits the power of the drive by the mold driver 932 to the movable mold 926. The mold clamper 930 moves the movable mold 926 using the mold driver 932 and the ball screw section 934 to thereby perform opening and closing of the mold section 920.

The embodiment and the modified example described above are illustrative only, and the present disclosure is not limited to the embodiment and the modified example. For example, it is also possible to arbitrarily combine the embodiment and the modified example with each other.

The present disclosure includes configurations substantially the same as the configuration described as the embodiment such as configurations having the same function, the same way, and the same result, or configurations having the same object and the same advantage. Further, the present disclosure includes configurations obtained by replacing a non-essential part of the configuration described as the embodiment. Further, the present disclosure includes configurations providing the same functions and advantages, and configurations capable of achieving the same object as those of the configuration described as the embodiment. Further, the present disclosure includes configurations obtained by adding a known technology to the configuration described as the embodiment.

The following contents derive from the embodiment and the modified example described above.

A plasticizing device according to an aspect includes a drive motor, a flat screw which has a groove forming surface provided with a groove, and rotates with the drive motor, a barrel which has an opposed surface opposed to the groove forming surface, and is provided with a communication hole, a heater configured to heat a material fed between the flat screw and the barrel, a cooler configured to cool an outer circumference of the flat screw, and a controller configured to control the drive motor, the heater, and the cooler, wherein the controller executes a plasticizing step of controlling the drive motor, the heater, and the cooler to plasticize the material fed between the flat screw and the barrel to make the material plasticized outflow from the communication hole, a stopping step of stopping at least the drive motor and the heater after executing the plasticizing step to stop the plasticizing step, and a start-up step of starting up the heater and controlling at least one of the heater and the cooler so that the outer circumference of the flat screw becomes at a temperature no higher than in the plasticizing step when resuming the plasticizing step after a predetermined time elapses from the stopping step.

According to this plasticizing device, it is possible to prevent the bridge phenomenon from occurring, and thus, it is possible to smoothly start up the device.

In the plasticizing device according to the aspect described above, the controller may rotate the flat screw after a predetermined time elapses from when starting up the heater in the start-up step.

According to this plasticizing device, it is possible to reduce the load on the drive motor.

In the plasticizing device according to the aspect described above, the controller may rotate the flat screw in the start-up step at a rotational speed lower than in the plasticizing step.

According to this plasticizing device, it is possible to reduce the load on the drive motor.

In the plasticizing device according to the aspect described above, the controller may control the cooler in the start-up step so that a temperature at the outer circumference of the flat screw becomes no higher than in the plasticizing step.

According to this plasticizing device, it is possible to prevent the material from being plasticized at the outer circumference of the flat screw.

In the plasticizing device according to the aspect described above, the controller may control the heater in the start-up step so that a temperature of the material becomes no lower than a plasticization temperature of the material, and no higher than in the plasticizing step.

According to this plasticizing device, it is possible to more surely prevent the material from being plasticized at the outer circumference of the flat screw.

In the plasticizing device according to the aspect described above, the opposed surface may have a region which becomes at a temperature no lower than the plasticization temperature of the material due to the heater, and the controller may control at least one of the heater and the cooler so that an area of the region in the start-up step becomes no larger than the area of the region in the plasticizing step.

According to this plasticizing device, it is possible to more surely prevent the material from being plasticized at the outer circumference of the flat screw.

In the plasticizing device according to the aspect described above, there may further be included a temperature sensor configured to detect a temperature of the groove forming surface or the opposed surface, wherein the controller may control at least one of the cooler, the heater, and the drive motor in the start-up step based on a detection value of the temperature sensor.

According to this plasticizing device, it is possible to smoothly execute the start-up step based on the detection value of the temperature sensor.

In the plasticizing device according to the aspect described above, there may further be included a pressure sensor configured to detect pressure in the communication hole, wherein the controller controls at least one of the cooler, the heater, and the drive motor in the start-up step based on a detection value of the pressure sensor.

According to this plasticizing device, it is possible to smoothly execute the start-up step based on the detection value of the pressure sensor.

In the plasticizing device according to the aspect described above, the controller may change the temperature at the outer circumference of the flat screw in accordance with a type of the material.

According to this plasticizing device, it is possible to optimize the temperature distribution in the flat screw and the barrel in accordance with the type of the material.

In the plasticizing device according to the aspect described above, the controller may make the temperature at the outer circumference of the flat screw higher when the material is a crystalline material compared to when the material is a non-crystalline material.

According to this plasticizing device, it is possible to optimize the temperature distribution in the flat screw and the barrel even when the material is the crystalline material.

A three-dimensional modeling device according to an aspect includes a plasticizing device configured to plasticize a material to obtain a plasticized material, and a nozzle configured to eject the plasticized material fed from the plasticizing device toward a stage, wherein the plasticizing device includes a drive motor, a flat screw which has a groove forming surface provided with a groove, and rotates with the drive motor, a barrel which has an opposed surface opposed to the groove forming surface, and is provided with a communication hole, a heater configured to heat a material fed between the flat screw and the barrel, a cooler configured to cool an outer circumference of the flat screw, and a controller configured to control the drive motor, the heater, and the cooler, and the controller executes a plasticizing step of controlling the drive motor, the heater, and the cooler to plasticize the material fed between the flat screw and the barrel to make the material plasticized outflow from the communication hole, a stopping step of stopping at least the drive motor and the heater after executing the plasticizing step to stop the plasticizing step, and a start-up step of starting up the heater and controlling at least one of the heater and the cooler so that the outer circumference of the flat screw becomes at a temperature no higher than in the plasticizing step when resuming the plasticizing step after a predetermined time elapses from the stopping step.

An injection molding device according to an aspect includes a plasticizing device configured to plasticize a material to obtain a plasticized material, and a nozzle configured to inject the plasticized material fed from the plasticizing device into a molding die, wherein the plasticizing device includes a drive motor, a flat screw which has a groove forming surface provided with a groove, and rotates with the drive motor, a barrel which has an opposed surface opposed to the groove forming surface, and is provided with a communication hole, a heater configured to heat a material fed between the flat screw and the barrel, a cooler configured to cool an outer circumference of the flat screw, and a controller configured to control the drive motor, the heater, and the cooler, and the controller executes a plasticizing step of controlling the drive motor, the heater, and the cooler to plasticize the material fed between the flat screw and the barrel to make the material plasticized outflow from the communication hole, a stopping step of stopping at least the drive motor and the heater after executing the plasticizing step to stop the plasticizing step, and a start-up step of starting up the heater and controlling at least one of the heater and the cooler so that the outer circumference of the flat screw becomes at a temperature no higher than in the plasticizing step when resuming the plasticizing step after a predetermined time elapses from the stopping step.

What is claimed is:

1. A plasticizing device comprising:
a drive motor;
a flat screw which has a groove forming surface provided with a groove, and rotates with the drive motor;
a barrel which has an opposed surface opposed to the groove forming surface, and is provided with a communication hole;
a heater configured to heat a material fed between the flat screw and the barrel;
a cooler configured to cool an outer circumference of the flat screw; and
a controller configured to control the drive motor, the heater, and the cooler, wherein
the controller executes
a plasticizing step of controlling the drive motor, the heater, and the cooler to plasticize the material fed between the flat screw and the barrel to make the material plasticized outflow from the communication hole,
a stopping step of stopping at least the drive motor and the heater after executing the plasticizing step to stop the plasticizing step, and
a start-up step of starting up the heater and controlling at least one of the heater and the cooler so that the outer circumference of the flat screw becomes at a temperature no higher than in the plasticizing step when resuming the plasticizing step after a predetermined time elapses from the stopping step.

2. The plasticizing device according to claim 1, wherein
the controller rotates the flat screw after a predetermined time elapses from when starting up the heater in the start-up step.

3. The plasticizing device according to claim 2, wherein
the controller rotates the flat screw in the start-up step at a rotational speed lower than in the plasticizing step.

4. The plasticizing device according to claim 1, wherein
the controller controls the cooler in the start-up step so that a temperature at the outer circumference of the flat screw becomes no higher than in the plasticizing step.

5. The plasticizing device according to claim 1, wherein
the controller controls the heater in the start-up step so that a temperature of the material becomes no lower than a plasticization temperature of the material, and no higher than in the plasticizing step.

6. The plasticizing device according to claim 1, wherein
the opposed surface has a region which becomes at a temperature no lower than the plasticization temperature of the material due to the heater, and
the controller controls at least one of the heater and the cooler so that an area of the region in the start-up step becomes no larger than the area of the region in the plasticizing step.

7. The plasticizing device according to claim 1, further comprising:
a temperature sensor configured to detect a temperature of the groove forming surface or the opposed surface, wherein
the controller controls at least one of the cooler, the heater, and the drive motor in the start-up step based on a detection value of the temperature sensor.

8. The plasticizing device according to claim 1, further comprising:
a pressure sensor configured to detect pressure in the communication hole, wherein
the controller controls at least one of the cooler, the heater, and the drive motor in the start-up step based on a detection value of the pressure sensor.

9. The plasticizing device according to claim 1, wherein
the controller changes the temperature at the outer circumference of the flat screw in accordance with a type of the material.

10. The plasticizing device according to claim 9, wherein
the controller makes the temperature at the outer circumference of the flat screw higher when the material is a crystalline material compared to when the material is a non-crystalline material.

11. A three-dimensional modeling device comprising:
a plasticizing device configured to plasticize a material to obtain a plasticized material; and
a nozzle configured to eject the plasticized material fed from the plasticizing device toward a stage, wherein
the plasticizing device includes
a drive motor,
a flat screw which has a groove forming surface provided with a groove, and rotates with the drive motor,
a barrel which has an opposed surface opposed to the groove forming surface, and is provided with a communication hole,
a heater configured to heat a material fed between the flat screw and the barrel,
a cooler configured to cool an outer circumference of the flat screw, and
a controller configured to control the drive motor, the heater, and the cooler, and
the controller executes
a plasticizing step of controlling the drive motor, the heater, and the cooler to plasticize the material fed between the flat screw and the barrel to make the material plasticized outflow from the communication hole,
a stopping step of stopping at least the drive motor and the heater after executing the plasticizing step to stop the plasticizing step, and
a start-up step of starting up the heater and controlling at least one of the heater and the cooler so that the outer circumference of the flat screw becomes at a temperature no higher than in the plasticizing step when resuming the plasticizing step after a predetermined time elapses from the stopping step.

12. An injection molding device comprising:
a plasticizing device configured to plasticize a material to obtain a plasticized material; and
a nozzle configured to inject the plasticized material fed from the plasticizing device into a molding die, wherein
the plasticizing device includes
a drive motor,
a flat screw which has a groove forming surface provided with a groove, and rotates with the drive motor,
a barrel which has an opposed surface opposed to the groove forming surface, and is provided with a communication hole,
a heater configured to heat a material fed between the flat screw and the barrel,
a cooler configured to cool an outer circumference of the flat screw, and
a controller configured to control the drive motor, the heater, and the cooler, and
the controller executes
a plasticizing step of controlling the drive motor, the heater, and the cooler to plasticize the material fed between the flat screw and the barrel to make the material plasticized outflow from the communication hole,
a stopping step of stopping at least the drive motor and the heater after executing the plasticizing step to stop the plasticizing step, and
a start-up step of starting up the heater and controlling at least one of the heater and the cooler so that the outer circumference of the flat screw becomes at a temperature no higher than in the plasticizing step when resuming the plasticizing step after a predetermined time elapses from the stopping step.
